(19) United States
(12) Patent Application Publication
(10) Pub. No.: US 2024/0144021 A1
(43) Pub. Date: May 2, 2024

(54) METHOD AND APPARATUS WITH MACHINE LEARNING MODEL

(71) Applicant: Samsung Electronics Co., Ltd., Suwon-si (KR)

(72) Inventors: Jihye KIM, Suwon-si (KR); Aristide BARATIN, Suwon-si (KR); Simon LACOSTE-JULIEN, Suwon-si (KR); Yan ZHANG, Suwon-si (KR)

(73) Assignee: Samsung Electronics Co., Ltd., Suwon-si (KR)

(21) Appl. No.: 18/341,892

(22) Filed: Jun. 27, 2023

(30) Foreign Application Priority Data
Nov. 2, 2022 (KR) 10-2022-0144209
Jan. 25, 2023 (KR) 10-2023-0009670

(51) Int. Cl. G06N 3/0895

(52) U.S. Cl. CPC G06N 3/0895

(57) ABSTRACT

An apparatus includes: one or more processors configured to: randomly split a training data set into a first training data set comprising a first label assigned to first data and a second training data set comprising a second label assigned to second data; train a first neural network using a semi-supervised learning scheme based on the first training data set comprising the first label, and an unlabeled second training data set; and train a second neural network using the semi-supervised learning scheme based on the second training data set comprising the second label, and an unlabeled first training data set.

### CROSS-REFERENCE TO RELATED APPLICATIONS

This application claims the benefit under 35 USC § 119(a) of Korean Patent Application No. 10-2022-0144209, filed on Nov. 2, 2022, and Korean Patent Application No. 10-2023-0009670, filed on Jan. 25, 2023, in the Korean Intellectual Property Office, the entire disclosures of which are incorporated herein by reference for all purposes.

### BACKGROUND

### 1. Field

The following description relates to an apparatus and method with a machine learning model.

### 2. Description of Related Art

Training a machine learning model to a high degree of accuracy may use large-scale labeled training data. However, acquiring clean labels for large-scale data sets may be incredibly challenging and expensive to achieve in practice, especially in a data domain in which the labelling cost is high, such as healthcare. Although a large quantity of labeled data, such as web data, may be obtained at a low cost, such data inevitably includes a large number of noise labels.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an apparatus includes: one or more processors configured to: randomly split a training data set into a first training data set comprising a first label assigned to first data and a second training data set comprising a second label assigned to second data; train a first neural network using a semi-supervised learning scheme based on the first training data set comprising the first label, and an unlabeled second training data set; and
train a second neural network using the semi-supervised learning scheme based on the second training data set comprising the second label, and an unlabeled first training data set.

The unlabeled first training data set may be generated by removing the first label from the first training data set, and the unlabeled second training data set may be generated by removing the second label from the second training data set.

For the training of the first neural network, the one or more processors may be configured to: output a first soft label by correcting the first training data set; and train the first neural network using the semi-supervised learning scheme based on the first training data set, the first soft label, and the unlabeled second training data set.

For the outputting of the first soft label, the one or more processors may be configured to: control the second neural network to estimate a first prediction label for the first training data set based on the first training data set; and correct the first label and the first prediction label to output the first soft label.

For the correcting of the first label and the first prediction label, the one or more processors may be configured to perform a convex combination on the first label and the first prediction label to output the first soft label.

For the training of the first neural network, the one or more processors may be configured to: control the first neural network to output a second pseudo label for the unlabeled second training data set; and train the first neural network using the semi-supervised learning scheme based on the first training data set, the first soft label, the unlabeled second training data set, and the second pseudo label.

For the training of the second neural network, the one or more processors may be configured to: output a second soft label by correcting the second training data set; and train the second neural network using the semi-supervised learning scheme based on the second training data set, the second soft label, and the unlabeled first training data set.

For the outputting of the second soft label, the one or more processors may be configured to: control the first neural network to estimate a second prediction label for the second training data set based on the second training data set; and correct the second label and the second prediction label to output the second soft label.

For the correcting of the second label and the second prediction label, the one or more processors may be configured to perform a convex combination on the second label and the second prediction label to output the second soft label.

For the training of the second neural network, the one or more processors may be configured to: control the second neural network to output a first pseudo label for the unlabeled first training data set; and train the second neural network using the semi-supervised learning scheme based on the second training data set, the second soft label, the unlabeled first training data set, and the first pseudo label.

The one or more processors may be configured to control a machine learning model to estimate a prediction label for input data, wherein the machine learning model comprises the trained first neural network and the trained second neural network.

The apparatus may include a memory storing instructions that, when executed by the one or more processors, configure the one or more processors to perform the randomly splitting of the training data set, the training of the first neural network, and the training of the second neural network.

In one or more general aspects, a processor-implemented method includes: randomly splitting a training data set into a first training data set comprising a first label assigned to first data and a second training data set comprising a second label assigned to second data; training a first neural network using a semi-supervised learning scheme based on the first training data set comprising the first label, and an unlabeled second training data set generated by removing the second label from the second training data set; and training a second neural network using the semi-supervised learning scheme based on the second training data set comprising the second label, and an unlabeled first training data set generated by removing the first label from the first training data set.

The training of the first neural network using the semi-supervised learning scheme may include: outputting a first soft label by correcting the first training data set; and training the first neural network using the semi-supervised learning scheme based on the first training data set, the first soft label, and the unlabeled second training data set, and the training of the second neural network using the semi-supervised learning scheme may include: outputting a second soft label by correcting the second training data set; and training the second neural network using the semi-supervised learning scheme based on the second training data set, the second soft label, and the unlabeled first training data set.

The outputting of the first soft label may include: estimating, by the second neural network, a first prediction label for the first training data set based on the first training data set; and correcting the first label and the first prediction label to output the first soft label, and the outputting of the second soft label may include: estimating, by the first neural network, a second prediction label for the second training data set based on the second training data set; and correcting the second label and the second prediction label to output the second soft label.

The correcting of the first label and the first prediction label may include performing a convex combination based on the first label and the first prediction label to output the first soft label, and the correcting of the second label and the second prediction label may include performing a convex combination based on the second label and the second prediction label to output the second soft label.

The training of the first neural network using the semi-supervised learning scheme may include: outputting a second pseudo label for the unlabeled second training data set using the first neural network; and training the first neural network using the semi-supervised learning scheme based on the first training data set, the first soft label, the unlabeled second training data set, and the second pseudo label, and the training of the second neural network using the semi-supervised learning scheme may include: outputting a first pseudo label for the unlabeled first training data set using the second neural network; and training the second neural network using the semi-supervised learning scheme based on the second training data set, the second soft label, the unlabeled first training data set, and the first pseudo label.

The method may include controlling a machine learning model to estimate a prediction label for input data, wherein the machine learning model may include the trained first neural network and the trained second neural network.

In one or more general aspects, a non-transitory computer-readable storage medium stores instructions that, when executed by a processor, configure the processor to perform any one, any combination, or all of operations and/or methods described herein.

In one or more general aspects, an apparatus includes: one or more processors configured to control a machine learning model to estimate a prediction label for input data, wherein the machine learning model may include a trained first neural network and a trained second neural network, wherein the trained first neural network is generated by training a first neural network using a semi-supervised learning scheme based on a first training data set comprising a first label assigned to first data, and an unlabeled second training data set generated by removing a second label from a second training data set comprising the second label assigned to second data, wherein the trained second neural network is generated by training a second neural network using the semi-supervised learning scheme based on the second training data set comprising the second label, and an unlabeled first training data set generated by removing the first label from the first training data set, and wherein the first training data set and the second training data set are generated by randomly splitting a training data set into the first training data set and the second training data set.

Other features and aspects will be apparent from the following detailed description, the drawings, and the claims.

### BRIEF DESCRIPTION OF THE DRAWINGS

FIG. 1 illustrates an example of an overview of an apparatus.

FIG. 2 illustrates an example of an operation of an apparatus.

FIG. 3 illustrates an example of an operation of an apparatus to train a machine learning model using a soft label.

FIG. 4 illustrates an example of an operation of an apparatus to train a machine learning model using a pseudo label.

FIG. 5 illustrates an example of an operation of training a machine learning model using three neural networks by an apparatus.

FIG. 6 illustrates an example of a training method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms, such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which the present disclosure pertains and based on an understanding of the disclosure of the present application. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment, e.g., as to what an example or embodiment may include or implement, means that at least one example or embodiment exists where such a feature is included or implemented, while all examples are not limited thereto.

Hereinafter, the examples will be described in detail with reference to the accompanying drawings. When describing the examples with reference to the accompanying drawings, like reference numerals refer to like components and a repeated description related thereto will be omitted.

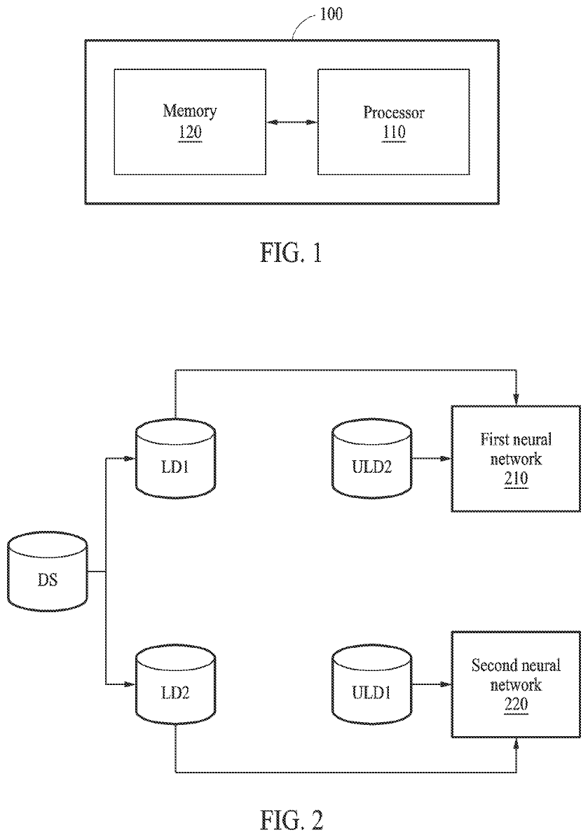

FIG. 1 briefly illustrates an example of an apparatus for training a machine learning model.

Referring to FIG. 1, an apparatus 100 may include a memory 120 (e.g., one or more memories) including instructions, and a processor 110 (e.g., one or more processors) configured to execute the instructions. The apparatus 100 of one or more embodiments may implement noise-robust models using a large quantity of training data including noise labels.

The processor 110 may control other components (e.g., hardware or software-implementing hardware components) of the apparatus 100 and may perform various types of data processing or operations. As at least a portion of the data processing or operations, the processor 110 may store, in the memory 120, instructions or data received from another component, may process the instructions or data stored in the memory 120, and store result data in the memory 120. Operations performed by the processor 110 may be substantially the same as those of the apparatus 100.

The memory 120 may store information necessary for the processor 110 to perform a processing operation. For example, the memory 120 may store instructions to be executed by the processor 110 and may store related information while software or a program is being executed in the apparatus 100. For example, the memory 120 may be or include a non-transitory computer-readable storage medium storing instructions that, when executed by the processor 110, configure the processor 110 to perform any one, any combination, or all of the operations and methods described herein with reference to FIGS. 1-6. The memory 120 may include a volatile memory, such as a random-access memory (RAM), a dynamic RAM (DRAM), and a static RAM (SRAM), and/or a known non-volatile memory such as a flash memory.

The apparatus 100 may train a machine learning model using a plurality of neural networks. The apparatus 100 may randomly split a received training data set into different training data sets, and train the plurality of neural networks based on the different training data sets. The plurality of neural networks trained based on the different training data sets may have different memorization characteristics.

A training data set may be a labeled data set. Labeling or tagging may be inputting a variety of information according to the purpose so that artificial intelligence such as machine learning may perform learning by utilizing a processing tool in data included in a training data set. Labeling may be performed when a machine learning model is trained using a supervised learning (SL) scheme or a semi-supervised learning (SSL) scheme among schemes of training a machine learning model.

Due to a high complexity of problems to be solved by machine learning and a great diversity of application fields, a labeling process of a typical apparatus may be more complicated. When a quantity of data is vast or an expert in a relevant field is needed to solve a problem requiring specialized knowledge, incorrect labeling may occur in the labeling process of the typical apparatus. When a person manually performs labeling for reliable labeling, a large amount of cost and time may be used, and when labeling is automated, noise may occur in the labeling process of the typical apparatus because there is no guarantee that labeling is always correct. In addition, in the labeling process of the typical apparatus, when insufficient validation fails to be performed due to lack of time or manpower, a data set may include a noise label.

An accuracy of labeling may have an influence on performance of the machine learning model. When training data includes a noise label, the typical apparatus may train the machine learning model based on the training data with mislabeled data. In addition, the typical apparatus may easily overfit the machine learning model to the noise label, which may result in a reduction in generalization performance of the machine learning model. Therefore, the apparatus 100 of one or more embodiments may train the machine learning model to be robust against the noise label.

A method of generating a machine learning model that is robust against a noise label may include, for example, a typical sample selection method of separating a clean label that is correctly labeled from a data set including a noise label for all training data sets. However, when the typical sample selection method is used, it may be difficult to separate a hard sample, which is difficult to be predicted by a machine learning model but useful for training, from noise labeled data.

According to an example of one or more embodiments, instead of performing the above typical sample selection method, a training data set may be randomly split into different data sets, and a plurality of neural networks may be trained based on a labeled training data set and an unlabeled training data set using a semi-supervised learning scheme. The semi-supervised learning scheme may be a scheme of training a model by properly mixing labeled training data and unlabeled training data, unlike a supervised learning (SL) scheme of training a model based on labeled training data and an unsupervised learning (UL) scheme of training a model based on unlabeled training data.

The processor 110 of the apparatus 100 of one or more embodiments may split a training data set into training data sets that are different from each other and train a plurality of neural networks, thereby mitigating side effects of memorizing a noise label of a neural network model by complementarily using predicted values of the neural networks for data. In an example, the apparatus 100 may be used, for example, to classify types of semiconductor wafer defects including noise labels. When labels of input data are inferred based on neural network models trained using the apparatus 100 of one or more embodiments, a reliability of such inference may increase. The labels of the input data may be inferred based on neural network models trained using the apparatus 100 by a combination of logit values output from each of the neural network models. For example, the labels of the input data may be inferred based on a maximum value among average values of the logit values output from each of the neural network models. Further, according to a non-limiting example, the apparatus 100 may control a machine learning model to estimate a prediction label for input data, wherein the machine learning model comprises the plurality of trained neural networks.

An example of training neural networks by a processor of an apparatus will be described in detail with reference to FIGS. 2 to 4 below.

FIG. 2 illustrates an example of an operation of an apparatus.

Referring to FIG. 2, an apparatus (e.g., the apparatus 100 of FIG. 1) for training a machine learning model may train a first neural network 210 and a second neural network 220 using a processor (e.g., the processor 110 of FIG. 1). The processor may train the first neural network 210 and the second neural network 220 based on a training data set DS. Depending on examples, the machine learning model may include at least two or at least three neural networks. For example, the machine learning model may include the first neural network 210 and the second neural network 220.

The processor may randomly split the training data set DS into a first training data set LD1 and a second training data set LD2 that are different from each other. The first training data set LD1 and the second training data set LD2 may be labeled training data sets.

The processor may train the first neural network 210 using a semi-supervised learning scheme, based on the first training data set LD1, a first label assigned to the first training data set LD1, and an unlabeled second training data set ULD2 obtained (e.g., generated) by removing a label value from the second training data set LD2. The processor may train the second neural network 220 using the semi-supervised learning scheme, based on the second training data set LD2, a second label assigned to the second training data set LD2, and an unlabeled first training data set ULD1 obtained by removing a label value from the first training data set LD1.

When the first neural network 210 learns the unlabeled second training data set ULD2 obtained by removing the label value from the second training data set LD2, a noise label included in the second training data set LD2 may not be learned. When the second neural network 220 learns the unlabeled first training data set ULD1 obtained by removing the label value from the first training data set LD1, a noise label included in the first training data set LD1 may not be learned.

The first neural network 210 may learn the first training data set LD1 and the second neural network 220 may learn the second training data set LD2, and accordingly the first neural network 210 and the second neural network 220 may be complementary to each other. The apparatus may train the first neural network 210 robust against noise labeled data included in the first training data set LD1, and the second neural network 220 robust against noise labeled data included in the second training data set LD2.

The apparatus may additionally train the first neural network 210 and the second neural network 220 using additional training data as an input for the first neural network 210 and the second neural network 220 that are already trained based on the existing training data set DS. The apparatus may additionally re-train the first neural network 210 and the second neural network 220 based on new training data, such that the first neural network 210 and the second neural network 220 may reflect characteristics of the new training data, to improve prediction reliability of the first neural network 210 and the second neural network 220.

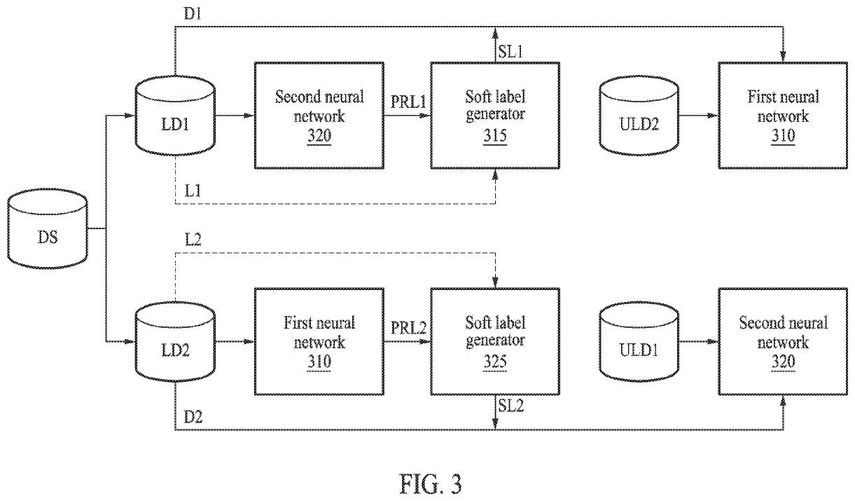

FIG. 3 illustrates an example of an operation of an apparatus to train a machine learning model using a soft label.

Referring to FIG. 3, an apparatus (e.g., the apparatus 100 of FIG. 1) may train a first neural network 310 and a second neural network 320 using a processor (e.g., the processor 110 of FIG. 1). The processor may train the first neural network 310 and the second neural network 320 based on a training data set DS. In an example, the machine learning model may include the first neural network 310 and the second neural network 320.

The processor may randomly split the training data set DS into a first training data set LD1 and a second training data set LD2 that are different from each other. The first training data set LD1 and the second training data set LD2 may be labeled training data sets.

The processor may train the first neural network 310 using a semi-supervised learning scheme based on a data set obtained by labeling first data D1 of the first training data set LD1 with a soft label SL1, and an unlabeled second training data set ULD2. The processor may train the second neural network 320 using the semi-supervised learning scheme based on a data set obtained by labeling second data D2 of the second training data set LD2 with a soft label SL2, and an unlabeled first training data set ULD1. In an example, as described above with reference to FIG. 2, the unlabeled second training data set ULD2 may be obtained by removing a label value from the second training data set LD2 and the unlabeled first training data set ULD1 may be obtained by removing a label value from the first training data set LD1.

The processor may control the second neural network 320 to receive the first training data set LD1, estimate a label for the first training data set LD1, and output a prediction label PRL1. The processor may control the first neural network 310 to estimate a label for the second training data set LD2, and output a prediction label PRL2. The second neural network 320 may transmit the prediction label PRL1 to a soft label generator 315. The first neural network 310 may transmit the prediction label PRL2 to a soft label generator 325.

The soft label generator 315 may receive a first label L1 from the first training data set LD1 and receive the prediction label PRL1 from the second neural network 320. The soft label generator 315 may output the soft label SL1 by correcting the prediction label PRL1 and the first label L1 of the first training data set LD1. For example, the soft label generator 315 may perform a convex combination on the prediction label PRL1 and the first label L1 of the first training data set LD1 to output the soft label SL1. However, a method of outputting the soft label SL1 by correcting the first label L1 and the prediction label PRL1 by the soft label generator 315 may vary according to examples.

The soft label generator 325 may receive a second label L2 from the second training data set LD2 and receive the prediction label PRL2 from the first neural network 310. The soft label generator 325 may output the soft label SL2 by correcting the second label L2 and the prediction label PRL2 of the second training data set LD2. For example, the soft label generator 325 may perform a convex combination on the prediction label PRL2 and the second label L2 of the second training data set LD2 to output the soft label SL2. However, a method of outputting the soft label SL2 by correcting the second label L2 and the prediction label PRL2 by the soft label generator 325 may vary according to examples.

Operations performed by the soft label generators 315 and 325 may be substantially the same as an operation performed by the processor. For example, the processor may include the soft label generators 315 and 325.

When the first training data set LD1 includes data xᵢ (e.g., D1 of FIG. 3) labeled with a label yᵢ (e.g., L1 of FIG. 3) and when the prediction label PRL1 output by the second neural network 320 is denoted by ŷ_{peer,i}, the soft label generator 315 may perform a convex combination on the label yᵢ of the data xᵢ and the prediction label ŷ_{peer,i}, to output a soft label sᵢ (e.g., SL1 of FIG. 3) as shown in Equation 1 below, for example.

sᵢ=βᵢŷ_{peer,i}+(1−βᵢ)yᵢ Equation 1

A parameter βᵢ may be a value between “0” and “1”. The value of the parameter βᵢ may decrease as an accuracy of a prediction of the label yᵢ of the data xᵢ by the second neural network 320 increases. When the value of the parameter βᵢ decreases, a value of the soft label sᵢ may approach a value of the label yᵢ of the data xᵢ.

The apparatus of one or more embodiments may alleviate memorization of noise labeled data included in the first training data set LD1 by training the first neural network 310 to learn data included in the first training data set LD1 using the soft label SL1 output by the soft label generator 315 instead of using the first label L1 labeled to the first training data set LD1. When the second neural network 320 learns unlabeled training data instead of learning labeled training data for the first training data set LD1, a noise label for the first training data set LD1 may not be learned.

The value of the parameter βᵢ in Equation 1 may be defined as shown in Equation 2 below, for example.

βᵢ=γ(JSDₙₒᵣₘ(ŷ_{peer,i},yᵢ)−0.5)+0.5 Equation 2

In Equation 2, γ denotes a parameter to adjust the value of the parameter βᵢ.

In Equation 2, a function JSDₙₒᵣₘ may be defined as shown in Equation 3 below, for example.

$${JSD}_{norm} ( {\hat{y}}_{peer , i} , {y}_{i} ) := \frac{JSD ( {\hat{y}}_{peer , i} , {y}_{i} ) - {JSD}_{{y}_{i}}^{min}}{{JSD}_{{y}_{i}}^{max} - {JSD}_{{y}_{i}}^{min}} \qquad Equation 3$$

The function JSDₙₒᵣₘ may be a normalized version of a Jensen-Shannon divergence.

JSD_{y}^{min} and JSD_{y}^{max} in Equation 3 may be defined as in Equations 4 and 5 below, respectively, for example.

$${JSD}_{y}^{min} := {min}_{\{ j \vert {y}_{j} = y \}} JSD ( {\hat{y}}_{peer , j} , y ) \qquad Equation 4$$

$${JSD}_{y}^{max} := {max}_{\{ j \vert {y}_{j} = y \}} JSD ( {\hat{y}}_{peer , j} , y ) \qquad Equation 5$$

The apparatus may calculate (e.g., determine) JSD_{y}^{min} and JSD_{y}^{max} for each label of data included in a training data set to calculate JSDₙₒᵣₘ(ŷ_{peer,i},yᵢ).

The apparatus of one or more embodiments may train the first neural network 310 to be robust against a noise label included in the first training data set LD1 by training the first neural network 310 based on data obtained by labeling first data D1 of the first training data set LD1 with the soft label SL1 output by the soft label generator 315, and based on the unlabeled second training data set ULD2 obtained by removing a label from the second training data set LD2. The apparatus of one or more embodiments may train the second neural network 320 to be robust against a noise label included in the second training data set LD2 by training the second neural network 320 based on data obtained by labeling second data D2 of the second training data set LD2 with the soft label SL2 output by the soft label generator 325, and based on the unlabeled first training data set ULD1 obtained by removing a label from the first training data set LD1.

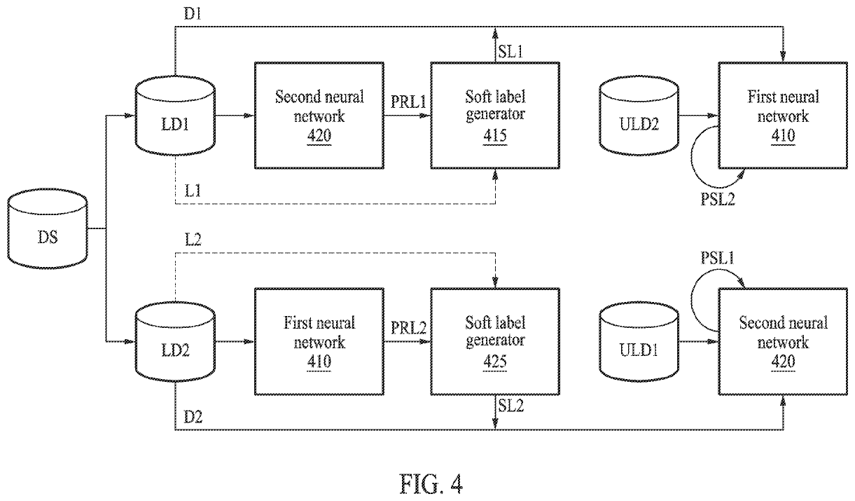

FIG. 4 illustrates an example of an operation of an apparatus to train a machine learning model using a pseudo label.

Referring to FIG. 4, an apparatus (e.g., the apparatus 100 of FIG. 1) may train a first neural network 410 and a second neural network 420 using a processor (e.g., the processor 110 of FIG. 1). The configuration and operation of the first neural network 410, the second neural network 420, and soft label generators 415 and 425 may be similar to those of the first neural network 310, the second neural network 320, and the soft label generators 315 and 325 described above with reference to FIG. 3.

In comparison to FIG. 3, the processor may control the first neural network 410 to output a pseudo label PSL2 for an unlabeled second training data set ULD2. Pseudo-labeling may be a scheme of assigning a label with a highest probability in a form of a virtual label to data. The first neural network 410 may learn a second training data set based on the unlabeled second training data set ULD2 and the pseudo label PSL2 output by the first neural network 410.

The processor may control the second neural network 420 to output a pseudo label PSL1 for an unlabeled first training data set ULD1. The second neural network 420 may learn a first training data set LD1 based on the unlabeled first training data set ULD1 and the pseudo label PSL1 output by the second neural network 420.

When the first neural network 410 learns data labeled with the pseudo label PSL2 in the unlabeled second training data set ULD2, learning of the unlabeled second training data set ULD2 by the first neural network 410 may not have an influence on estimating a label of the second training data set LD2 and outputting the prediction label PRL2. When the second neural network 420 learns data labeled with the pseudo label PSL1 in the unlabeled first training data set ULD1, learning of the unlabeled first training data set ULD1 by the second neural network 420 may not have an influence on estimating a label of the first training data set LD1 and outputting the prediction label PRL1.

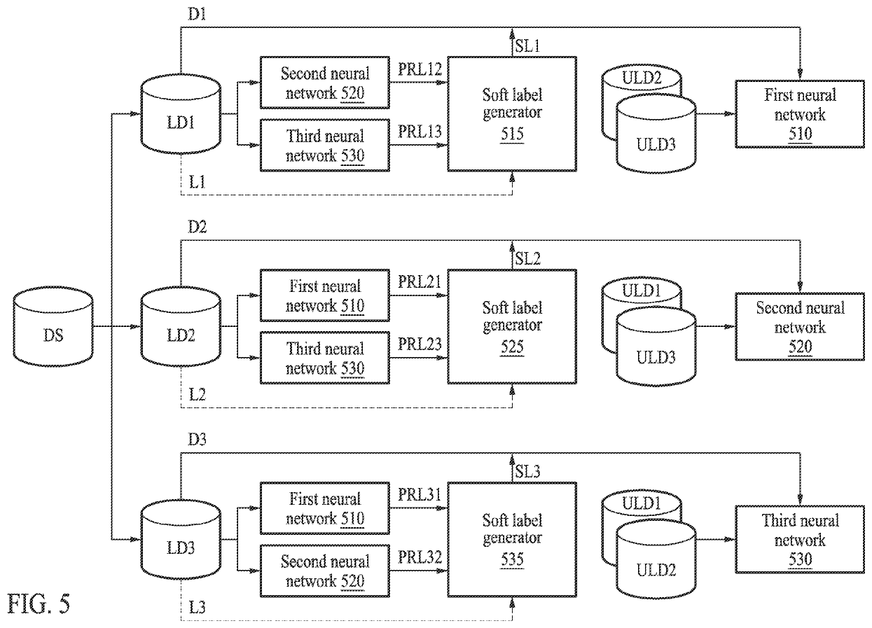

FIG. 5 illustrates an example of an operation of training a machine learning model using three neural networks by an apparatus.

Referring to FIG. 5, an apparatus (e.g., the apparatus 100 of FIG. 1) may include a first neural network 510, a second neural network 520, a third neural network 530, and soft label generators 515, 525, and 535. The apparatus may receive a training data set DS and train the first neural network 510, the second neural network 520, and the third neural network 530.

The apparatus may receive the training data set DS and randomly split the training data set DS into a first training data set LD1, a second training data set LD2, and a third training data set LD3. The first training data set LD1, the second training data set LD2, and the third training data set LD3 may be labeled training data sets.

The first neural network 510 may be trained using a semi-supervised learning scheme based on a data set obtained by labeling first data D1 of the first training data set LD1 with a soft label SL1, an unlabeled second training data set ULD2, and an unlabeled third training data set ULD3.

The second neural network 520 may be trained using the semi-supervised learning scheme based on a data set obtained by labeling second data D2 of the second training data set LD2 with a soft label SL2, an unlabeled first training data set ULD1, and the unlabeled third training data set ULD3.

The third neural network 530 may be trained using the semi-supervised learning scheme based on a data set obtained by labeling data D3 of the third training data set LD3 with a soft label SL3, the unlabeled first training data set ULD1, and the unlabeled second training data set ULD2.

Various methods of training three different neural networks by the apparatus may be provided. For example, the apparatus may train the first neural network 510 based on the unlabeled first training data set ULD1, the second training data set LD2, and the third training data set LD3, may train the second neural network 520 based on the unlabeled second training data set ULD2, the first training data set LD1, and the third training data set LD3, and may train the third neural network 530 based on the unlabeled third training data set ULD3, the first training data set LD1, and the second training data set LD2.

In this example, in a process of training the first neural network 510, the second training data set LD2 may be corrected based on the second neural network 520, and the third training data set LD3 may be corrected based on the third neural network 530. In a process of training the second neural network 520, the first training data set LD1 may be corrected based on the first neural network 510, and the third training data set LD3 may be corrected based on the third neural network 530. In a process of training the third neural network 530, the first training data set LD1 may be corrected based on the first neural network 510, and the second training data set LD2 may be corrected based on the second neural network 520.

However, a method by which the apparatus trains different neural networks is not limited thereto and may vary according to examples. Hereinafter, for convenience of description, description will be provided on an example in which the first neural network 510 is trained based on the first training data set LD1, the unlabeled second training data set ULD2, and the unlabeled third training data set ULD3, in which the second neural network 520 is trained based on the second training data set LD2, the unlabeled first training data set ULD1, and the unlabeled third training data set ULD3, and in which the third neural network 530 is trained based on the third training data set LD3, the unlabeled first training data set ULD1, and the unlabeled second training data set ULD2.

The first training data set LD1 may be transmitted to the second neural network 520 and the third neural network 530. The second neural network 520 may receive the first training data set LD1, estimate a label for the first training data set LD1, and output a prediction label PRL12. The second neural network 520 may transmit the prediction label PRL12 to the soft label generator 515.

The third neural network 530 may receive the first training data set LD1, estimate a label for the first training data set LD1, and output a prediction label PRL13. The third neural network 530 may transmit the prediction label PRL13 to the soft label generator 515.

The soft label generator 515 may receive a first label L1 assigned to the first training data set LD1, and receive the prediction labels PRL12 and PRL13 from the second neural network 520 and the third neural network 530. The soft label generator 515 may correct the prediction labels PRL12 and PRL13 and the first label L1 of the first training data set LD1 to output the soft label SL1. The outputting of the soft label SL1 by the soft label generator 515 may be understood based on the example described above with reference to FIG. 3.

Outputting of the soft labels SL2 and SL3 by the soft label generators 525 and 535 may be similar to the outputting of the soft label SL1 by the soft label generator 515. The first neural network 510 may be trained to be robust against a noise label included in the first training data set LD1, the second neural network 520 may be trained to be robust against a noise label included in the second training data set LD2, and the third neural network 530 may be trained to be robust against a noise label included in the third training data set LD3. The first neural network 510, the second neural network 520, and the third neural network 530 may be complementary to each other.

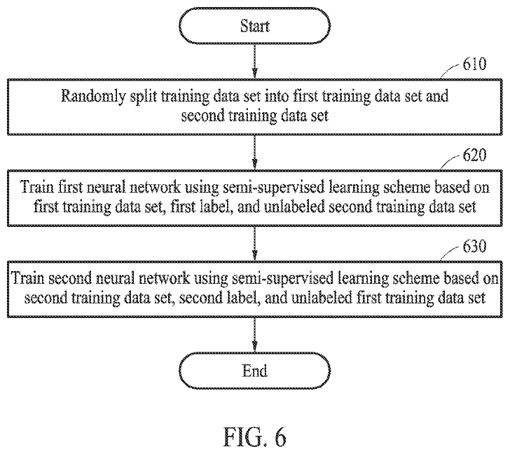

FIG. 6 illustrates an example of a training method.

For example, operations of a training method of training a machine learning model may be performed by the apparatus 100 of FIG. 1. Some of operations of FIG. 6 may be performed simultaneously or in parallel to another operation and the order of operations may change. In addition, some of the operations may be omitted or another operation may be additionally performed.

In operation 610, an apparatus may randomly split a training data set into a first training data set and a second training data set. The first training data set and the second training data set may be labeled training data sets.

In operation 620, the apparatus may train a first neural network using a semi-supervised learning scheme, based on the first training data set, a first label labeled to the first training data set, and an unlabeled second training data set. The unlabeled second training data set may be a data set obtained by removing a label from the second training data set. The apparatus may output a second soft label by correcting the second data set, and train a second neural network using the semi-supervised learning scheme, based on the second data set, the second soft label, and an unlabeled first training data set.

The training of the first neural network using the semi-supervised learning scheme comprises outputting a first soft label by correcting the first training data set; and training the first neural network using the semi-supervised learning scheme based on the first training data set, the first soft label, and the unlabeled second training data set. The training of the second neural network using the semi-supervised learning scheme comprises outputting a second soft label by correcting the second training data set, and training the second neural network using the semi-supervised learning scheme based on the second training data set, the second soft label, and the unlabeled first training data set.

An operation of outputting the first soft label by the apparatus may include an operation of estimating, by the second neural network, a label for the first training data set and outputting a first prediction label, and an operation of correcting the first label and the first prediction label to output the first soft label. The operation of outputting the first soft label by the apparatus may include an operation of performing a convex combination based on the first label and the first prediction label to output the first soft label. A method by which the apparatus corrects the first label and the first prediction label to output the first soft label may vary according to examples. The operation of performing the convex combination based on the first label and the first prediction label to output the first soft label by the apparatus will be understood based on the example described above with reference to FIG. 3.

Operation 620 of training the first neural network using the semi-supervised learning scheme may include an operation of outputting a second pseudo label for the unlabeled second training data set using the first neural network, and an operation of training the first neural network using the semi-supervised learning scheme based on the first training data set, the first soft label, the unlabeled second training data set, and the second pseudo label. Pseudo-labeling may be a scheme of assigning a label with a highest probability in a form of a virtual label to data. When the first neural network learns data labeled with a pseudo label in the second training data set, noise labeled data included in the second training data set may not be learned.

In operation 630, the apparatus may train the second neural network using the semi-supervised learning scheme, based on the second training data set, a second label labeled to the second training data set, and the unlabeled first training data set.

The operation of outputting the second soft label by the apparatus may include an operation of estimating, by the first neural network, a label for the second training data set and outputting a second prediction label, and an operation of correcting the second label and the second prediction label to output the second soft label. The operation of correcting the second label and the second prediction label to output the second soft label by the apparatus will be understood based on the example described above with reference to FIG. 3. The operation of outputting the second soft label by the apparatus may include an operation of performing a convex combination on the second label and the second prediction label to output the second soft label.

Operation 630 of training the second neural network using the semi-supervised learning scheme may include an operation of outputting a first pseudo label for the unlabeled first training data set using the second neural network, and an operation of training the second neural network using the semi-supervised learning scheme based on the second training data set, the second soft label, the unlabeled first training data set, and the first pseudo label. When the second neural network learns data labeled with a pseudo label in the first training data set, noise labeled data included in the first training data set may not be learned.

The apparatus may randomly split an input training data set into different training data sets and train different neural networks based on the different training data sets, to train a machine learning model that is robust to noise labels.

The apparatuses, memories, processors, soft label generators, apparatus 100, memory 120, processor 110, soft label generator 315, soft label generator 325, soft label generator 515, soft label generator 525, soft label generator 535, and other apparatuses, devices, units, modules, and components disclosed and described herein with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus, the apparatus comprising:
one or more processors configured to:
randomly split a training data set into a first training data set comprising a first label assigned to first data and a second training data set comprising a second label assigned to second data;
train a first neural network using a semi-supervised learning scheme based on the first training data set comprising the first label, and an unlabeled second training data set; and
train a second neural network using the semi-supervised learning scheme based on the second training data set comprising the second label, and an unlabeled first training data set.

2. The apparatus of claim 1, wherein
the unlabeled first training data set is generated by removing the first label from the first training data set, and
the unlabeled second training data set is generated by removing the second label from the second training data set.

3. The apparatus of claim 1, wherein, for the training of the first neural network, the one or more processors are configured to:
output a first soft label by correcting the first training data set; and
train the first neural network using the semi-supervised learning scheme based on the first training data set, the first soft label, and the unlabeled second training data set.

4. The apparatus of claim 2, wherein, for the outputting of the first soft label, the one or more processors are configured to:
control the second neural network to estimate a first prediction label for the first training data set based on the first training data set; and
correct the first label and the first prediction label to output the first soft label.

5. The apparatus of claim 3, wherein, for the correcting of the first label and the first prediction label, the one or more processors are configured to perform a convex combination on the first label and the first prediction label to output the first soft label.

6. The apparatus of claim 2, wherein, for the training of the first neural network, the one or more processors are configured to:
control the first neural network to output a second pseudo label for the unlabeled second training data set; and
train the first neural network using the semi-supervised learning scheme based on the first training data set, the first soft label, the unlabeled second training data set, and the second pseudo label.

7. The apparatus of claim 1, wherein, for the training of the second neural network, the one or more processors are configured to:
output a second soft label by correcting the second training data set; and
train the second neural network using the semi-supervised learning scheme based on the second training data set, the second soft label, and the unlabeled first training data set.

8. The apparatus of claim 6, wherein, for the outputting of the second soft label, the one or more processors are configured to:
control the first neural network to estimate a second prediction label for the second training data set based on the second training data set; and
correct the second label and the second prediction label to output the second soft label.

9. The apparatus of claim 7, wherein, for the correcting of the second label and the second prediction label, the one or more processors are configured to perform a convex combination on the second label and the second prediction label to output the second soft label.

10. The apparatus of claim 6, wherein, for the training of the second neural network, the one or more processors are configured to:
control the second neural network to output a first pseudo label for the unlabeled first training data set; and
train the second neural network using the semi-supervised learning scheme based on the second training data set, the second soft label, the unlabeled first training data set, and the first pseudo label.

11. The apparatus of claim 1, wherein the one or more processors are configured to control a machine learning model to estimate a prediction label for input data, wherein the machine learning model comprises the trained first neural network and the trained second neural network.

12. The apparatus of claim 1, further comprising a memory storing instructions that, when executed by the one or more processors, configure the one or more processors to perform the randomly splitting of the training data set, the training of the first neural network, and the training of the second neural network.

13. A processor-implemented method, the method comprising:
randomly splitting a training data set into a first training data set comprising a first label assigned to first data and a second training data set comprising a second label assigned to second data;
training a first neural network using a semi-supervised learning scheme based on the first training data set comprising the first label, and an unlabeled second training data set generated by removing the second label from the second training data set; and
training a second neural network using the semi-supervised learning scheme based on the second training data set comprising the second label, and an unlabeled first training data set generated by removing the first label from the first training data set.

14. The method of claim 13, wherein
the training of the first neural network using the semi-supervised learning scheme comprises:
outputting a first soft label by correcting the first training data set; and
training the first neural network using the semi-supervised learning scheme based on the first training data set, the first soft label, and the unlabeled second training data set, and
the training of the second neural network using the semi-supervised learning scheme comprises:
outputting a second soft label by correcting the second training data set; and
training the second neural network using the semi-supervised learning scheme based on the second training data set, the second soft label, and the unlabeled first training data set.

15. The method of claim 14, wherein
the outputting of the first soft label comprises:
estimating, by the second neural network, a first prediction label for the first training data set based on the first training data set; and
correcting the first label and the first prediction label to output the first soft label, and
the outputting of the second soft label comprises:
estimating, by the first neural network, a second prediction label for the second training data set based on the second training data set; and
correcting the second label and the second prediction label to output the second soft label.

16. The method of claim 15, wherein
the correcting of the first label and the first prediction label comprises performing a convex combination based on the first label and the first prediction label to output the first soft label, and
the correcting of the second label and the second prediction label comprises performing a convex combination based on the second label and the second prediction label to output the second soft label.

17. The method of claim 14, wherein
the training of the first neural network using the semi-supervised learning scheme comprises:
outputting a second pseudo label for the unlabeled second training data set using the first neural network; and
training the first neural network using the semi-supervised learning scheme based on the first training data set, the first soft label, the unlabeled second training data set, and the second pseudo label, and
the training of the second neural network using the semi-supervised learning scheme comprises:
outputting a first pseudo label for the unlabeled first training data set using the second neural network; and
training the second neural network using the semi-supervised learning scheme based on the second training data set, the second soft label, the unlabeled first training data set, and the first pseudo label.

18. The method of claim 13, further comprising controlling a machine learning model to estimate a prediction label for input data, wherein the machine learning model comprises the trained first neural network and the trained second neural network.

19. A non-transitory computer-readable storage medium storing instructions that, when executed by one or more processors, configure the one or more processors to perform the method of claim 13.

20. An apparatus, the apparatus comprising:
one or more processors configured to control a machine learning model to estimate a prediction label for input data,
wherein the machine learning model comprises a trained first neural network and a trained second neural network,
wherein the trained first neural network is generated by training a first neural network using a semi-supervised learning scheme based on a first training data set comprising a first label assigned to first data, and an unlabeled second training data set generated by removing a second label from a second training data set comprising the second label assigned to second data,
wherein the trained second neural network is generated by training a second neural network using the semi-supervised learning scheme based on the second training data set comprising the second label, and an unlabeled first training data set generated by removing the first label from the first training data set, and
wherein the first training data set and the second training data set are generated by randomly splitting a training data set into the first training data set and the second training data set.
